(19) United States
(12) Patent Application Publication
(10) Pub. No.: US 2003/0147389 A1
(43) Pub. Date: Aug. 7, 2003

(54) Method for transmitting broadband, ip-based data streams in a point-to-many-points communications network

(76) Inventor: Wolfgang Zirwas, Grobenzell (DE)

Correspondence Address: STAAS & HALSEY LLP, 700 11TH STREET, NW, SUITE 500, WASHINGTON, DC, 20001, US

(21) Appl. No.: 10/257,242

(22) PCT Filed: Apr. 10, 2001
(86) PCT No.: PCT/DE01/01403

(30) Foreign Application Priority Data
Apr. 11, 2000 (DE) 10017929.0

(51) Int. Cl. H04L 12/28

(52) U.S. Cl. 370/390

(57) ABSTRACT

The invention relates to a method for transmitting broadband, IP-based data streams in a point-to-many points communications network, based on a mobile radiotelephone network. According to said method, a universal multicast channel is installed in the cells of the mobile radiotelephone network for transmitting IP-based multicast data streams from a base station (RBS) to subscriber-end terminals (RNT).

The invention relates to a method for transmitting broadband, IP-based data streams in a point-to-multipoint communications network, and to a device for this purpose.

If not only one transmitter and one receiver communicate, but a number of transmitters and receivers in each case communicate with one another selectively, then this is referred to as a communications network. The subscribers can communicate via electrically conductive or optical conductors or via radio waves as carriers for the information. If mobile subscriber access devices are integrated in the communications network via a radio interface, then this is a mobile radio network. Well-known digital mobile radio networks include, for example, DECT (Digital European Cordless Telecommunications) and GSM (Global System for Mobile Communications). UMTS (Universal Mobile Telecommunications System) is currently being set up, this being a 3rd generation mobile radio system, in which the first-mentioned networks will be included. Furthermore, so-called wire-free subscriber access networks are known, in which the subscriber access is provided over the so-called last mile by means of a radio link.

Data is transmitted either as a point-to-point transmission (Unicasting) from one transmitter to one receiver or as a point-to-multipoint transmission (Broadcasting) from one transmitter to a number of receivers. The latter form of transmission is typical of broadcast radio and television, and is increasingly also used for telematics services in mobile radio and subscriber access systems. A characteristic feature of point-to-multipoint transmission in a mobile radio network nowadays is still the unidirectional traffic, namely from a specific transmitter to in each case one mobile subscriber station or subscriber access device.

The amounts of data to be transmitted will increase dramatically in the further-developing and future communications networks. This is due, for example, to the more stringent quality requirements for television transmissions (HDTV) and greatly increasing Internet traffic, such as the WWW (World Wide Web), which has a graphics user interface, FTP (File Transfer Protocol), e-mail (electronic mail) or electronic newspaper. These services are based on packet-orientated transmission of data and, owing to the nature of the information to be transmitted and the large amounts of data to be transmitted, they in general demand short delay times and high transmission rates, which should be understood as meaning the set of data symbols (bits) to be transmitted per unit time. While present-day radio communications networks—such as GSM—are still designed for simple speech and data services with low-rate data transmission at about 10 kbps, the land line digital EURO-ISDN network with a transmission rate of 64 kbps or, when two channels are bundled, at 128 kbps, extremely high-rate transmissions at 20 Mbps, 50 mbps and, in the long term, even more, will be required in future communications systems for particularly demanding services, such as audio transmissions, video conferences, video telephone or television.

Based on the currently known data transmission methods, transmission channels with a very wide bandwidth of 2 GHz up to the range of tens of Gigahertz will be required for this purpose. Even taking account of the fact that, for example, glass-fiber cables and the radio interface for this purpose can be used in frequency bands in the 100 THz band or more, it quickly becomes clear that, taking into account the explosive growth in subscribers and despite all the progress in the multiple use of channels (multiplexing), the resources in future fixed and mobile broadband systems must be utilized as efficiently as possible, in order to prevent network overloading.

Within the Internet worldwide computer network, extension of the normal Internet Protocol (IP) is known for group communication, namely multicast addressing. A multicast address does not identify an individual computer, but a group of computers which are combined to form a local area network (LAN). The extended Internet Protocol IP multicast provides a mechanism for this purpose, on the basis of which a server does not send a copy of its compressed digitized data to each individual computer in the LAN, but only once to the LAN multicast address. Thus, if a member is interested in a range of audio and/or video data, it registers in the LAN rather than with the server.

Since conventional IP routers, which are required for connection of the individual LANs for the Internet, do not have a multicast capability, network elements with a multicast capability remain isolated as multicasting islands in the Internet. Tunneling mechanisms have been developed for connection of these islands, by means of which a worldwide multicast network has been set up, entitled MBone (Multicast Backbone). The audio, video and data channels are copied by the routers in the network themselves on the basis of the number of required receivers, and are connected downstream to those computers who wish to receive this, from network node to network node via a type of tree structure.

In consequence, only the amount of data which is required by the computers or routers which are adjacent in the tree structure need be transported and there is no need to simultaneously offer a data load, which is completely unnecessary in some circumstances, to all the computers. The system thus effectively avoids unused or repeatedly identical data traffic passing through the same network section, and thus helps to save resources. Mbone is used, for example, for synchronous communication, such as interactive multiparty conferences, teaching courses, etc.

The high data rates to be transmitted and the broadband real-time services, with the requirement for short latency times, also demand a new quality for future radio communications networks. While the rapid extension of photonic networks may result in the bottlenecks in the core network being of minor importance, access to the data via the radio interface represents a virtually insurmountable bottleneck.

The invention is thus based on the object of making it possible to use the advantages of a multicasting network for a mobile radio system aswell, in order to counteract the predicated dramatic rise in the amounts of data to be transmitted, which demands new solutions for data access.

According to the invention, the object is achieved by the features specified in claim 1 for a method, and by the features specified in claim 12 for a device for carrying out the method.

According to the invention, a universal multicast channel is set up in the radio cells of a radio network for the transmission of IP-based multicast data to the subscriber-end access devices. A subscriber-end access device that wishes to receive registers an IP-based data stream that it wishes to receive with the base station associated with it, and the base station tells it the identifier for the desired data stream. In the situation where a number of subscriber-end access devices request the same IP-based data stream, the data stream therefore need be sent (broadcast) only once from the base station via the multicast channel according to the invention. The individual subscriber-end access devices filter the respectively desired data stream out of the multicast channel on the basis of the identifier for the relevant IP data packets. In the situation where no access device at all in a radio cell requests an IP-based data stream, it also need not be transmitted on the multicast channel.

The invention at the same time makes the technical implementation of a standard, all-encompassing communications network feasible, including all the distribution services in the most widely differing fields, and all the capabilities of interactive services can be used within the scenario.

In conjunction with the already existing and future enormous databank archives and worldwide information services, this will lead to completely new opportunities both for international collaboration and for international competition.

The already used terrestrial television and broadcast radio frequencies are becoming free and can be used more economically, specifically no longer just for one service, but for any desired services by means of wire-free, high-speed Internet access. At the same time, this will improve the economy for the service provider.

Interactive television as practiced today, in which services are integrated in virtual form from two different networks on a common user interface, may already satisfy the requirements of the information providers in many respects, but will not allow such versatile use as an actually integrated solution.

Furthermore, it should not be forgotten that further use of separate networks cements the monopoly of the broadcast radio and television providers for the distribution of high-quality “life events”. This contradicts the fundamental idea of complete freedom of information on the Internet. In the long term, it will thus be possible to introduce any desired local event into a standard communications network, without having to make use of a television transmitter for this purpose.

Although offline transmissions and local storage facilities for moving picture sequences, for example, ameliorate the problem of having to transmit very high data rates, they are in general no longer as up-to-date as required. However, this is extraordinarily important for a very large number of subscribers. Furthermore, this technology requires considerable additional control complexity.

The introduction of the invention advantageously allows the digital transmission of radio programs (Digital Audio Broadcasting DAB) to be replaced by DAB-Internet (DAB-I), and allows television programs (Digital Video Broadcasting DVB) to be replaced by DVB Internet (DVB-I). Direct satellite reception will then still be provided to an ever greater extent only in areas of low population density.

A further advantage of the invention is that all subscriber access devices for all services will communicate with only a single common communications network using the same data format (IP data packets) via a standard radio interface, irrespective of whether this is a television set, a mobile telephone, an industrial process controller, a domestic alarm system, or a microwave cooker.

The use of a standard technology without the necessity for special networks for the individual services, as is now necessary, will also lead to cost optimization in the long term.

The invention will be explained in more detail with reference to an exemplary embodiment.

In the associated drawing:

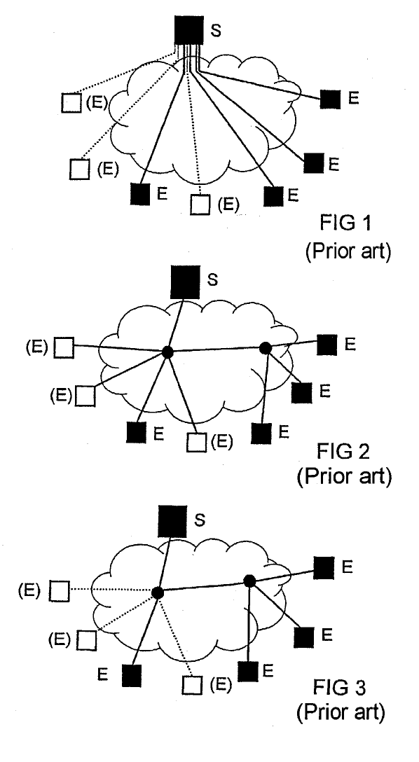

FIGS. 1 to 3 show examples of known network configurations of point-to-multipoint connections, and

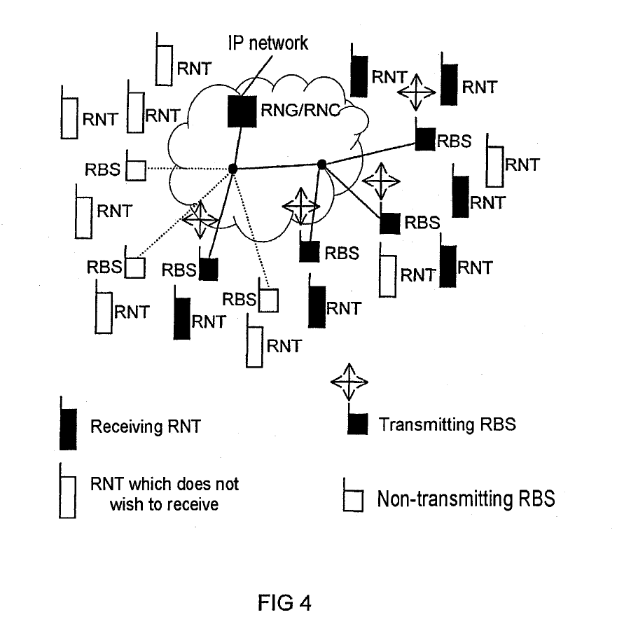

FIG. 4 shows the multicast configuration of a mobile radio network according to the invention.

FIG. 1 shows, schematically, a unicast configuration of a point-to-multipoint communications connection. The expression point-to-multipoint connection is intended to mean the capability to transmit information from one transmitter S to a number of receivers E.

A dedicated link is set up from the transmitter S to each receiver E in a unicast system, via which the data to be disseminated is transmitted. As the numbers of users increase, the network load also rises linearly. There is also a high load on the transmitter S itself, since it must provide the data individually for each receiver E, and must filter out the desired information from all the information which is provided. Telephone traffic via the Internet may be cited as one example of a use of the Unicast configuration.

FIG. 2 shows, schematically, a broadcast configuration for a communications network. On this basis, the transmitter S sends one and the same data stream to all the connected receivers E at the same time. Broadcasting is, for example, typical for broadcast radio and television. Modern telematics services broadcast short messages and other information in a mobile radio system. This configuration leads to unwanted data traffic when only a subset of the connected receivers E are interested in the data, as is generally the case. The smaller this subset, the greater the amount of resources which are wasted.

Finally, FIG. 3 shows, schematically, a multicast configuration. The transmitter S transmits a single data stream. Each receiver E who wishes to receive it registers with its network node. These network nodes pass the data stream to the receivers E, or copy it to them, as required. The major advantage is that only the useful data traffic is transported. Multicasting is used in local area networks and in the MBone system on the Internet. The data stream is transmitted only once, from the server to all the client programs. Multicast routers carry out the copying of the data stream, which may be required.

FIG. 4 shows, schematically, a multicast configuration for a mobile radio network according to the invention. In the example, an RNG/RNC (Radio Network Gateway/Radio Network Controller) is connected to an IP network and, on request, receives all the information which is available in the IP network and has been released for it.

In this context, the Internet Protocol (IP) provides data packets in a standard format, each of which has a specific information technology significance. The data packets are routed independently of one another on their way from a transmitter to a receiver, to be precise on a packet-switching basis, on the basis of which each data packet may in principle take a different route, or by means of virtual line switching, which provides a compromise between line switching and packet switching. It is therefore necessary to identify the data packets. For this purpose, signaling information is added to each data packet. The signaling information includes, inter alia, an Internet address, which is subdivided into four classes, Class D with the address start numbers 224 to 239 being used for multicast connections.

The IP-based data stream is copied to the relevant network nodes in the tree structure of the mobile radio network to which subscriber-end access devices RNT (Radio Network Terminations) which wish to receive it are connected, and the relevant base stations RBS (Radio Base Stations) broadcast the data which is desired by at least one access device RNT in the area of its radio cell. The data stream is not transported to nodes and base stations RBS to which no access devices RNT which wish to receive the relevant IP-based data stream are connected at that time. The expression access device should in this case be understood as being representative of any type of subscriber terminals with a multicast capability which can be integrated in the mobile radio system and can receive IP-based data by radio, that is to say, for example, mobile stations which are equipped for this purpose, fixed-position subscriber stations, notebooks, television sets or intelligent domestic appliances. The critical factor is that all the subscriber-end access devices RNT use the same data format (IP data packets) and communicate in a standard IP-based network on the basis of a standard technology.

In the simplest case, all the signals in the direction of the subscriber-end access devices RNT are bundled in a single broadband signal, for example using time-division multiplexing.

The wish of a subscriber for, for example, a specific TV program is transmitted by means of suitable signaling to the base station RBS. This requests the desired TV program for the subscriber in the external IP network, and stores information about the chosen TV program in a register. Before the data is passed to the access device RNT, the base station RBS identifies all the IP data packets associated with this TV program, by means of a specific entry in the header.

The base station RBS can thus note that a subscriber has chosen a specific TV signal. If a further subscriber in the network wishes to receive the same TV program, then the base station RBS informs its access device, in this case a video signal receiving device with this capability, via the associated identifier of the IP data packets which contain this TV program. The signaling information may in this case be transmitted bidirectionally, for example in special IP packets with addresses which are defined only locally in the network. Since, in point-to-multipoint systems, these are transmitted in any case to all the subscriber-end access devices RNT, the corresponding base station RBS can sort out the IP data packets associated with the desired TV program, can decode them and can provide them to the subscriber in a suitable manner for reproduction on his access device RNT. No new channels therefore need be used for a subscriber or the further subscribers who are interested in an already transmitted TV program and have registered with the base station RBS for this purpose. According to the invention, the base station RBS carries out the function of an intelligent, fixed-position agent for the procurement, administration and local distribution of distribution information which, of course, may also be of a different type than the TV programs, which are quoted merely by way of example. The term agent in this case means a program which possibly has a learning capability, or a software unit or else a hardware unit, which is able to carry out specific operations as ordered by a subscriber or some other agent on the basis of decision algorithms.

In principle, any type of data stream may be distributed from the Internet, such as music, push information, advertising. At the same time, if requested by the subscriber, the base station RBS can also carry out a filter function, for example suppressing undesired advertising, provided that this can be identified as such in the base station RBS.

1. A method for transmitting broadband, IP-based data streams in a point-to-multipoint communications network, in which
a universal multicast channel for the transmission of broadband, IP-based multicast data streams from a base station (RBS) to subscriber-end access devices (RNT) is provided in the radio cells of the communications network
and subscriber-end access devices (RNT) which wish to receive register desired data streams with the base station (RBS), and the base station (RBS) tells them an identifier for the desired data streams.

2. The method as claimed in claim 1, in which,
in the situation where a number of subscriber-end access devices (RNT) request the same data stream, the data stream is sent only once from the base station (RBS) to the subscriber-end access devices (RNT), on the multicast channel.

3. The method as claimed in claim 2, in which
the subscriber-end access devices (RNT) use the identifier for the IP data packets to filter the data streams desired by them out of the multicast channel.

4. The method as claimed in one of the preceding claims, in which
information relating to a data stream which has been chosen by a subscriber-end access device (RNT) is stored in a register or in a database in a base station (RBS).

5. The method as claimed in one of the preceding claims, in which
base station (RBS) marks all the IP data packets which are associated with a requested data stream by means of a header in the IP data packets before passing them on in the direction of the subscriber-end access device (RNT).

6. Method as claimed in claim 5, in which
in the event of further requests for a data stream which has already been sent on the multicast channel, the base station (RBS) tells the requesting subscriber-end access devices (RNT) the identifier of the IP data packets which contain the data stream.

7. The method as claimed in claim 6, in which
signaling information is transmitted between a base station (RBS) and the access devices (RNT) in specific IP packets with addresses which are defined locally in the network.

8. The method as claimed in one of the preceding claims, in which IP-based data streams are bundled on the multicast channel using a time-division multiplex component.

9. The method as claimed in one of the preceding claims, in which
digital transmission of radio programs (Digital Audio Broadcasting) and/or television programs (Digital Video Broadcasting) take place or takes place via the multicast channel.

10. The method as claimed in one of the preceding claims, in which an intelligent, fixed-position agent in a base station (RBS) takes over the procurement, administration, filtering, distribution and/or billing for the data streams.

11. A device for transmitting broadband, IP-based data streams in a point-to-multipoint communications network, as claimed in claim 1.

12. The device as claimed in claim 11, in which
the communications system is in the form of a mobile radio system or a wire-free subscriber access system.
